(19) United States
(12) Patent Application Publication
(10) Pub. No.: US 2026/0148032 A1
(43) Pub. Date: May 28, 2026

(54) Wristbands Having RFID Circuits with Antenna Segments

(71) Applicant: Zebra Technologies Corporation, Lincolnshire, IL (US)

(72) Inventors: Steven J. Vandercar, Rolling Meadows, IL (US); Chad E. Tripp, Jacksonville, FL (US)

(21) Appl. No.: 18/962,216

(22) Filed: Nov. 27, 2024

(51) Int. Cl. G06K 19/077; H01Q 1/22; H01Q 1/27; H01Q 9/14

(52) U.S. Cl. CPC G06K 19/07737; H01Q 1/2225; H01Q 1/273; H01Q 9/14

(57) ABSTRACT

A wristband has a flexible elongated body with an open state in which the wristband is capable of being positioned in a planar configuration and a closed state in which the wristband is wrapped in a loop. An RFID circuit is supported by the body and is positioned on the body such that the RFID circuit is configured to be included in the loop when the wristband is in the closed state. The RFID circuit includes an antenna and one or more lines of weakness in the antenna. The one or more lines of weakness define tearable antenna segments that are removeable to change a length of the antenna of the RFID circuit.

### BACKGROUND

Wristbands that include radiofrequency identification device (RFID) inlays typically suffer from readability issues due to interference, e.g., from the body of the wearer of the wristband and the surrounding environment. The impact of the readability issues can vary based on a position of the RFID inlays relative to the body of the wearer and the RFID reader and can be particularly exasperated when the wrist of the wearer is positioned between the RFID inlay and the RFID reader.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a schematic plan view of an example of a wristband in accordance with embodiments of the present disclosure.

FIG. 1B is a schematic plan view of an example of a wristband in accordance with embodiments of the present disclosure.

FIG. 1C is a schematic profile view of an example of a wristband in accordance with embodiments of the present disclosure.

FIG. 1D illustrates an example of a wristband with a tearable antenna segment removed from the wristband along a line of weakness in accordance with embodiments of the present disclosure.

FIG. 2 is a schematic plan view of an example wristband including holes to facilitate securing the wristband in a loop in accordance with embodiments of the present disclosure.

FIG. 3A is a schematic plan view of an example configuration of an antenna of an example wristband in accordance with embodiments of the present disclosure.

FIG. 3B illustrates an example of a wristband with a tearable antenna segment with the antenna segment removed from the wristband along a line of weakness and a body of the wristband removed along a different line of weakness in accordance with embodiments of the present disclosure.

FIG. 4A-B illustrates an embodiment of an example wristband in a closed state in which the wristband is wrapped in a loop in accordance with embodiments of the present disclosure.

FIG. 4C illustrates an embodiment of an example wristband in a closed state in which the wristband is wrapped in a loop around a wrist of a wearer in accordance with embodiments of the present disclosure.

FIG. 5 is a block diagram of an example embodiment of the RFID circuit in accordance with embodiments of the present disclosure.

FIG. 6 illustrates an example of a system including an RFID reader and a wristband in accordance with embodiments of the present disclosure.

FIG. 7 illustrates an example web of wristbands in accordance with embodiments of the present disclosure.

FIG. 8 illustrates an example sheet of wristbands in accordance with embodiments of the present disclosure.

FIG. 9 is a flowchart illustrating an example process in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of the present disclosure are related to systems and/or devices that include a wristband with a radiofrequency identification device (RFID) circuit and provide for enhanced readability of the RFID circuit via segmented antenna(s) that can be selectively removed from the wristband to change a length of the antennas and wristbands based on a size of a wrist of a wearer around which the wristband will be looped. The wristband can advantageously improve a read range of the RFID circuit, can increase the read angle of the RFID circuit, and/or can aid in overcoming the effect and/or impact of radiofrequency interference or other issues caused by overlapping antenna portions when the wristbands are wrapped around the wrist of the wearer. The antenna extends circumferentially around the wristband when the wristband is wrapped around the wrist, ankle, or other body part of the wearer and removal of one or more segments of the antenna can minimize or eliminate any overlap between the terminal ends of the antenna. With this arrangement, the wristband can be personalized to the wearer and readability of the RFID circuit can be improved and/or can be independent of the orientation of the RFID circuit in the wristband.

The selective segmentation of the antenna of embodiments of the wristbands of the present disclosure can provide a “universal” wristband that allows wearers having different wrist diameters to use the same wristband while avoiding or mitigating issues that occur when parts of the RFID circuit overlap each other (e.g., when the antenna overlaps itself). For example, the same wristband can be worn by children and adults, and while the wristband may be wrapped about itself on the wrist of the wearer, the amount of overlap between terminal ends of the antenna can be controlled by selectively removing segments of the wristband.

In accordance with embodiments of the present disclosure, a device is disclosed. The device includes a wristband having a flexible elongated body. The wristband has an open state in which the wristband is capable of being positioned in a planar configuration and has a closed state in which the wristband is wrapped in a loop such that a first end of the wristband overlaps a second end of the wristband and is fixed to the body. The device also includes an RFID circuit supported by the elongated body of the wristband. The RFID circuit is positioned on the body such that the RFID circuit is configured to be included in the loop when the wristband is in the closed state. The RFID circuit includes an antenna. The device also includes a line of weakness in the antenna. The line of weakness defines a tearable antenna segment that is removeable to change a length of the antenna.

In accordance with embodiments of the present disclosure, a method is disclosed. The method includes supporting an RFID circuit on an elongated flexible body of a wristband. The wristband has an open state in which the wristband is capable of being positioned in a planar configuration and has a closed state in which the wristband is wrapped in a loop such that a first end of the wristband overlaps a second end of the wristband and is fixed to the body. The RFID circuit has an antenna and is positioned on the body such that the RFID circuit is configured to be included in the loop when the wristband is in the closed state. The method also includes forming one or more lines of weakness in the antenna to define tearable antenna segments that are removeable to change a length of the antenna.

In accordance with embodiments of the present disclosure, the antenna extends over fifty percent to one hundred percent of a length of the elongated body.

In accordance with embodiments of the present disclosure, the tearable segment is extends over five percent to fifty percent of the wristband.

In accordance with embodiments of the present disclosure, the device further includes a plurality of lines of weakness include the line of weakness, the plurality of lines of weakness defining a plurality of tearable antenna segments. The length of the antenna changes based on a quantity of the plurality of tearable antenna segments that are removed.

In accordance with embodiments of the present disclosure, a segment length of each tearable antenna segment is between approximately a quarter of an inch and approximately three inches.

In accordance with embodiments of the present disclosure, each of the plurality of antenna segments have an equal segment length.

In accordance with embodiments of the present disclosure, at least two of the plurality of antenna segments have different segment lengths.

In accordance with embodiments of the present disclosure, each of the plurality of antenna segments extend over two percent to twenty-five percent of the length of the elongated body.

In accordance with embodiments of the present disclosure, the line of weakness extends across the antenna. The device can include a further line of weakness offset from the line of weakness. The further line of weakness extends across the elongated body. The line of weakness and the further line of weakness define the tearable antenna segment. The antenna is tearable along the line of weakness and the elongated body is tearable along the further line of weakness.

In accordance with embodiments of the present disclosure, a portion of the antenna remaining intact in the wristband is offset inward from a remaining end of the elongated body when the tearable antenna segment is removed.

In accordance with embodiments of the present disclosure, the elongated body has a length of between eight inches and fifteen inches when the tearable antenna segment is intact and has a length of between three inches and ten inches when the tearable segment is removed.

In accordance with embodiments of the present disclosure, the length of the antenna is equal to a wavelength of an interrogation signal to which the RFID circuit is configured to respond when the tearable antenna segment is intact and the length of the antenna is one quarter of the wavelength or one half of the wavelength when the tearable antenna segment is removed.

In accordance with embodiments of the present disclosure, the antenna includes first antenna portion and a second antenna portion, the second antenna portion having a width that is less then the first antenna portion and the line of weakness extends across the second antenna portion.

In accordance with embodiments of the present disclosure, a maximum diameter of the loop formed by the wristband in closed position is between three inches and five inches when the tearable antenna segment is attached and is between one inch and two and a half inches when the antenna segment is removed.

In accordance with embodiments of the present disclosure, the antenna is a dipole antenna.

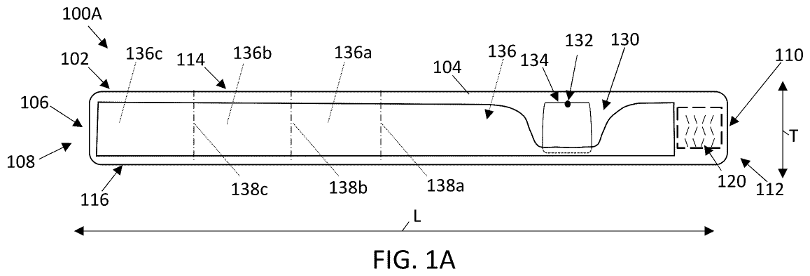

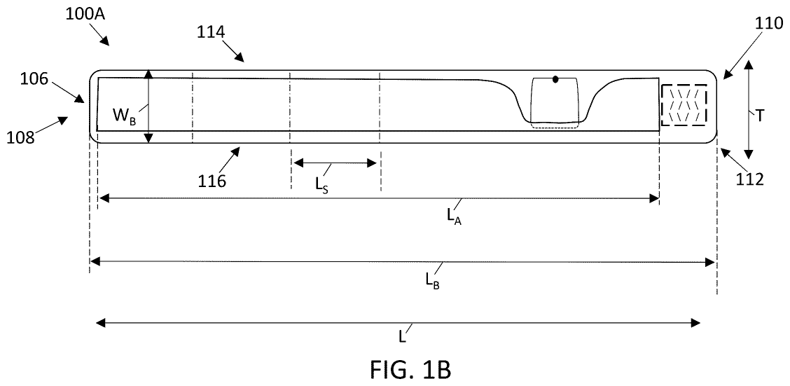

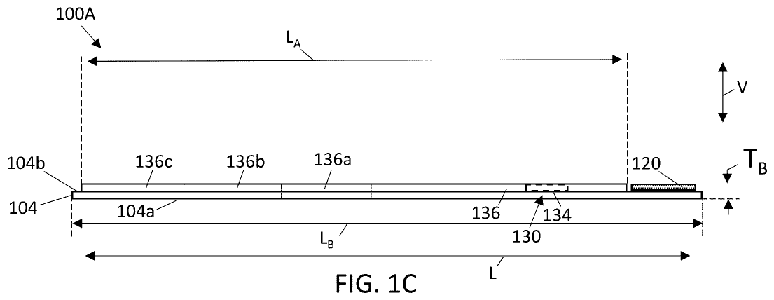

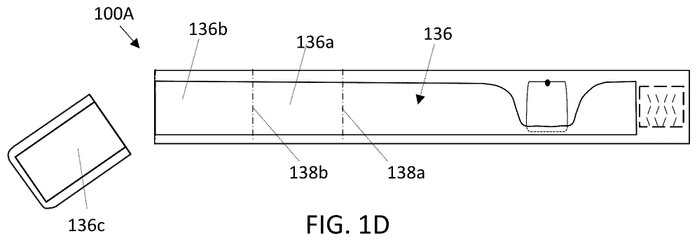

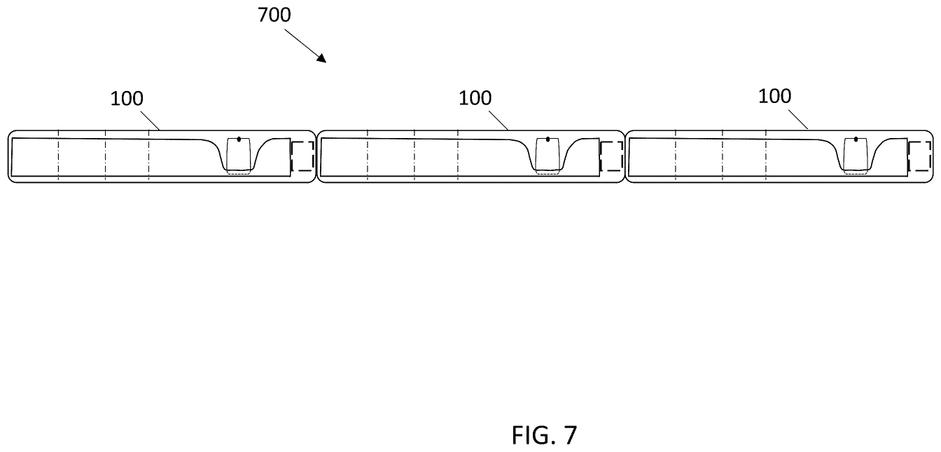

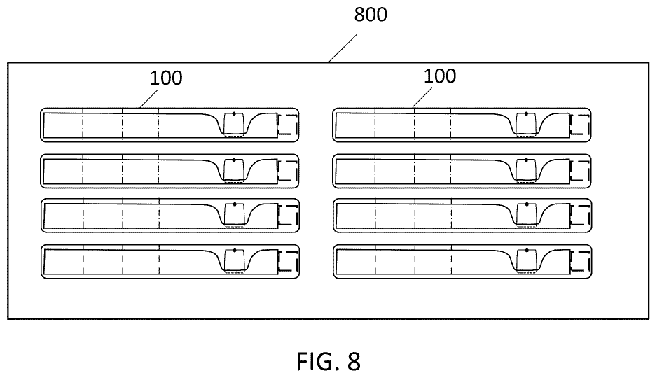

FIGS. 1A-D illustrate an example embodiment of a wristband or band 100A in an open position in accordance with embodiments of the present disclosure. FIGS. 1A-B are schematic plan views of the example wristband 100A and FIG. 1C is a schematic profile view of the example wristband 100A. FIG. 1D illustrates the example wristband 100A with an antenna segment torn along a line of weakness in accordance with embodiments of the present disclosure. The wristband 100A can have an elongated body 102, shown in FIGS. 1A-D in an open state in which the wristband 100A is capable of being positioned in a planar configuration. The body 102 can be formed from a flexible and/or non-rigid substrate 104 (having surface 104a and 104b). As an example, the substrate 104 can be formed from one or more of paper, elastomers, polymers, and/or any combination thereof. Polymers used to form the substrate 104 can include, for example, polyesters, thermoplastic and/or vinyl polymers, such as polypropylene, polyethylene, polyethylene terephthalate, nylon, and/or Tyvek®, other materials, and/or any combination thereof. The substrate 104 or at least a portion thereof provides a printable surface upon which indica can be printed, e.g., via thermal printing by a thermal printer. The wristband 100A can be provided individually and/or multiple wristbands 100A can be stored in a web 700 of wristbands where the wristbands are aligned end-to-end, as shown in FIG. 7, and/or can be stored in a sheet 800 of wristbands 100A where the wristbands 100A are distributed on the sheet, as shown in FIG. 8. To print on the substrates 104 of the wristbands 100A, the web 700 and/or sheet 800 can be fed through a printer.

The wristband 100A can be wrapped about an arm or wrist of a wearer (e.g., a human wearing the wristband). While the wristband 100A can be wrapped about the arm or wrist of the wearer, the wristband 100A can be also be wrapped about other parts of the human body, such as a leg or an ankle, can be wrapped about parts of animal's bodies, such as legs, neck, and/or other parts of the body, and/or can be wrapped about inanimate objects.

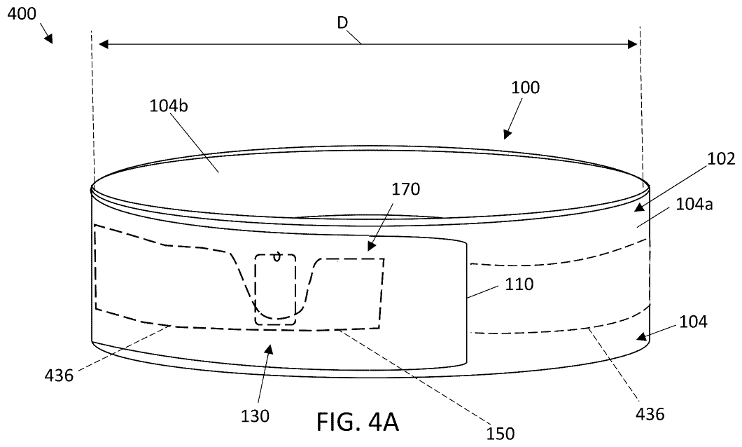

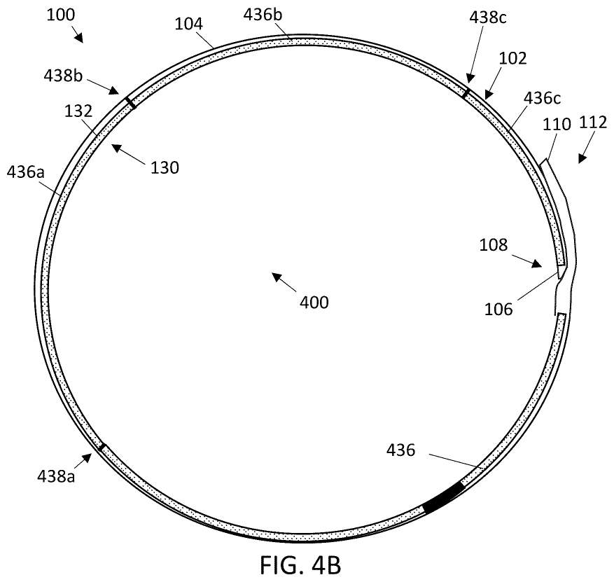

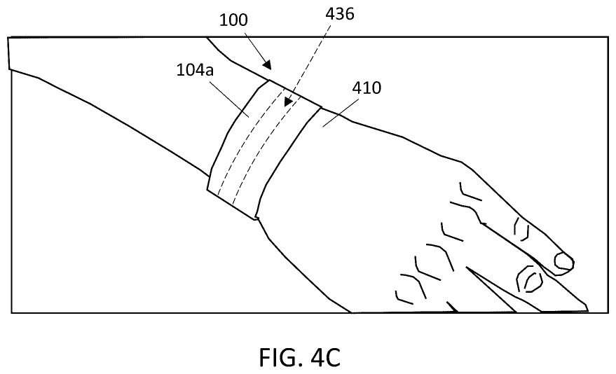

The body 102 can have a length L_{B} measured along a longitudinal axis L from a terminal end 106 at a proximal end 108 of the body 102 to a terminal end 110 at a distal end 112. As used herein, proximal ends generally refer to ends of components on the left side relative to each other in the orientation illustrated in FIGS. 1A-D and distal ends generally refer to ends of components on the right side relative to each other in the orientation illustrated in FIGS. 1A-D. The length L_{B} of the body 102 can be, for example, approximately eight (8) inches to approximately twenty (20) inches or approximately eight (8) inches to approximately fifteen (15) inches. As shown in FIGS. 1A-D, the wristband 100A can have a first (open) state in which the wristband 100A can be positioned in a planar configuration where the terminal ends 106 and 110 can be free. The wristband 100A can have a second (closed) state in which the wristband is fixed in a loop (e.g., FIGS. 4A-C where the wristband 100A is looped around itself and at least one of the terminal ends 106 or 110 is fixed, fastened, or otherwise secured to the body 102) to wrap the wristband 100A about a wearer of the wristband 100A. The body 102 can have a width WB measured along a transverse axis T from an edge 114 to an edge 116 of the body 102. In one example, the width WB can be between approximately one quarter (0.25) of an inch to approximately three (3) inches or between approximately one (1) inch and approximately two (2) inches. A thickness TB of the wristband 100A can be measured along a vertical axis V. The transverse axis T, the longitudinal axis L, and the vertical axis V are each perpendicular to each other. In one example, the body 102 can have a generally rectangular perimeter with a uniform width along the longitudinal axis L from the terminal end 106 to the terminal end 110.

While the body 102 is illustrated as having a generally rectangular perimeter, the body 102 can have differently shaped perimeters and/or the width WB can vary or be non-uniform along the longitudinal axis L from the terminal end 106 to the terminal end 110.

A radiofrequency identification device (RFID) circuit 130 can be supported by the body 102. The RFID circuit 130 includes an electronic circuit 132, an inductive loop 134, and an antenna 136 which in the present example is illustrated as a dipole antenna. The antenna 136 can be coupled to the inductive loop 134 and the inductive loop 134 can be coupled to the electronic circuit 132. In some embodiments, the antenna 136 and the inductive loop 134 can be integrally formed. While the inductive loop 134 has been described independently from the antenna 136, the inductive loop 134 can form a portion of the antenna 136. The antenna 136 has a length L_{A} and extends along the longitudinal axis L. The length L_{A} of the antenna 136 can extend over between approximately fifty percent (50%) and approximately one hundred percent (100%) of the length L_{B} of the wristband 100A, can extend over between approximately seventy percent (75%) and approximately one hundred percent (100%) of the length L_{B} of the wristband 100A, or can extend over between approximately ninety percent (90%) and approximately one hundred percent (100%) of the length L_{B} of the wristband 100A.

As shown in FIGS. 1A-D, the antenna 136 can have tearable antenna segments 136a-c. The tearable antenna segments 136a-c be defined by lines of weakness 138a-c (e.g., formed/fabricated at the time of or manufacture or as part of a manufacturing process). In one example, the lines of weakness can include cuts, slits, perforations, and/or scores that allow a user to tear the antenna segments 136a-c (and portions of the wristband including the antenna segments) from a remainder of the antenna 136 (and wristband 100A). The antenna segments 136a-c can be torn by the user without the user of a tool. The antenna segment 136c can extend between the terminal end 106 and the line of weakness 136c, the antenna segment 136b can extend between the lines of weakness 136b and 136c, and the antenna segment 136a can extend between the lines of weakness 138a and 138b. In one example, a segment length Lₛ of each of the antenna segments 136a-c can be equal. In one example, the segment length Lₛ of at least two of the antenna segments 136a-c can be different. In one example, the segment length L_{S} of each of the antenna segments 136a-c can be between approximately three quarters (0.75) inches and approximately three (3) inches (e.g., which can correspond to a reduction in a maximum diameter of a loop formed by the wristband 100A of between approximately one quarter of an inch and approximately one inch when each tearable antenna segment is torn from the wristband 100A) or between approximately one quarter (0.25) inches and approximately three (3) inches. In one example, the segment length L_{S} of each of the antenna segments 136a-c can be approximately one and half (1.5) inches (e.g., which can correspond to a reduction in a maximum diameter of a loop formed by the wristband 100A of approximately one half inch when each tearable antenna segment is torn from the wristband 100A). In one example, the length L_{B} of the body can be between three inches and ten inches when one or more of the tearable segments 136a-c are removed and/or can be between three (3) inches and six (6) inches when each of the tearable segments 136a-c are removed. The length L_{S} of each of the antenna segments 136a-c can be between approximately two percent (2%) and approximately twenty-five percent (25%) of the length L_{A} of the antenna 136 or between approximately ten percent (10%) and approximately twenty percent (20%) of the length L_{A} of the antenna 136. In one example, the length L_{S} of each of the antenna segments 136a-c can extend over between approximately two percent (2%) and approximately twenty-five percent (25%) of the length L_{B} of the wristband 100A or between approximately ten percent (10%) and approximately twenty percent (20%) of the length L_{B} of the wristband 100A. In one example, one of the aggregate length of the antenna segments 136a-c can extend over between approximately twenty-five percent (25%) and approximately seventy-five percent (75%) of the length L_{B} of the wristband 100A (or the length of L_{A} of the antenna 136) or between approximately twenty-five percent (25%) and approximately fifty percent (50%) of the length L_{B} of the wristband 100A (or the length of L_{A} of the antenna 136). As shown in FIG. 1D, the antenna segments 136c has been torn from the wristband along the line of weakness 138c. By selectively tearing the antenna segments 136a-c based on the size of a wrist of a wearer, an amount of overlap between the ends of the antenna 136 can be reduced or eliminated when the wristband 100A is wrapped around a wrist of a wearer and the interference or other issues resulting from such overlap can be reduced or eliminated.

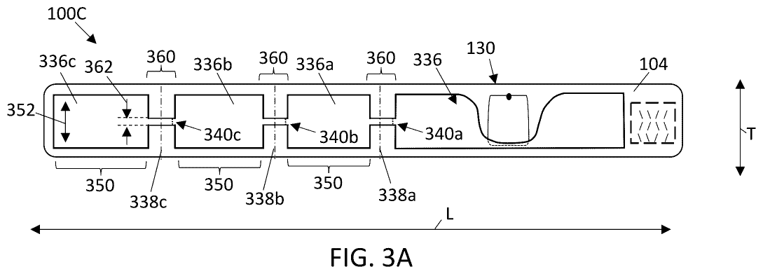

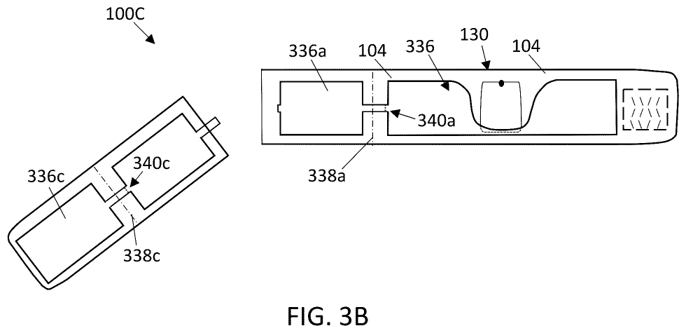

While the antenna 136 has been illustrated as a generally linear antenna, embodiments of the present disclosure can include other antenna configurations in which the antenna segments 136a-c have a different configuration. An example of another antenna configuration for the antenna 136 is illustrated in FIG. 3. Furthermore, while the antenna segments 136a-c have been illustrated as linear, rectangular segments, embodiments of the antenna segments 136a-c can have different configurations, such as a serpentine configuration. The wristband 100A can also include separate lines of weakness for the elongated body 102 (or substrate 104) and the antenna 136 for the antenna segments 136a-c. An example, of such separate lines of weakness have been illustrated in FIGS. 3A-B and apply to the wristband 100A.

The length L_{A} of the antenna 136 and/or a remaining length of the antenna 136 when one or more of the antenna segments 136a-c have been torn can be specified or tuned based on a wavelength of the radiofrequency communication to be received and/or transmitted by the RFID circuit 130. As an example, the length of the antenna 136 can be equal to the wavelength, a fraction of the wavelength, such as three quarters of the wavelength, one half of the wavelength, one quarter of the wavelength, one eighth of the wavelength, or other fractions of the wavelength. As an example, the length L_{A} of the antenna 136 can be approximately two inches to approximately twenty-four inches. As an example, the length L_{A} of the antenna 136 can be two inches, three inches, four inches, six inches, nine inches, twelve inches, sixteen inches, twenty inches, or twenty-four inches. In one non-limiting example, the length L_{A} of the antenna 136 with the tearable antenna segments 136a-c intact can be equal to the wavelength and each of the antenna segments 136a-c can be a quarter of a wavelength such that when the antenna segment 136c is torn from a remainder of the antenna 136, the length L_{A} of the antenna is reduce to three quarters of the wavelength; when the antenna segments 136b-c are torn from a remainder of the antenna 136, the length L_{A} of the antenna is reduce to a half of the wavelength; and when the antenna segments 136a-c are torn from a remainder of the antenna 136, the length L_{A} of the antenna 136 is reduce to one quarter of the wavelength.

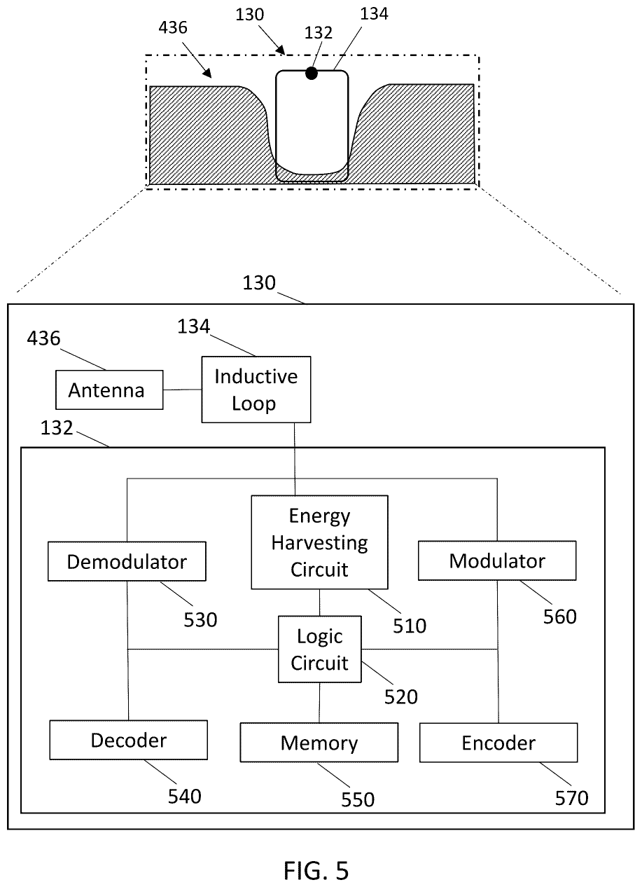

The RFID circuit 130 can be readable as described herein by a corresponding radiofrequency device, such as an RFID reader/interrogator. The RFID circuit 130 can be an ultra-high frequency (UHF) RFID circuit configured for far-field radiofrequency communication (e.g., in a frequency range of approximately 860 MHz to approximately 960 MHz). As a non-limiting example, the RFID circuit 130 can be configured according to one or more proprietary schemes and/or according to one or more standards, such as ISO 18000-6A, ISO 18000-6B, ISO 18000-6C, ISO/IEC 29143, and/or other standards. The electronic circuit 132 can be electrically connected to the inductive loop 134, which in turn can be electrically coupled to or integrally formed with the antenna 136, and the electronic circuit 132 can be operative to respond to a far-field radiofrequency communication via the inductive loop 134 and antenna 136. The RFID circuit 130 can be a passive RFID circuit and the inductive loop 134 and antenna 136 can power the electronic circuit 132 via inductive coupling in response to radiofrequency waves, e.g., emitted by the RFID reader/interrogator, which induce an electric current in the antenna 136 and the inductive loop 134. An example RFID circuit 130 is described herein with reference to FIG. 5.

One or more coatings can be applied to the substrate 104 and/or the RFID circuit 130. As a non-limiting example, the one or more coatings can include a silver antimicrobial coating, a varnish, and/or a soft feel coating. Additionally, or in the alternative, the RFID circuit 130 can be disposed between two substrates 104 (e.g., a first substrate and a second substrate), which can encompass the RFID circuit 130.

The RFID circuit 130, or portions thereof, can be adhered, welded, laminated, printed, or otherwise bonded to the substrate 104. The RFID circuit 130 of the wristband 100A can be disposed on one of the surfaces 104a-b of the substrate 104.

Referring to FIGS. 1A-D, the wristband 100A can include an adhesive 120 disposed at the terminal end 110, which can be used to affix the terminal end 110 to the body 102 to form a loop with the wristband 100A. The terminal end 110 and the adhesive 120 can form a tamper evident tab. The adhesive 120 can be disposed on a substrate 104.

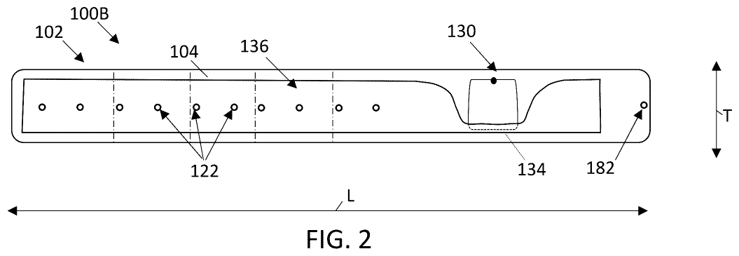

Additionally, or in the alternative, an embodiment of the wristband can include holes along a length of the wristband 100. A wristband 100B including holes 122 along a length of the wristband 100B is shown in FIG. 2, where the wristband 100B generally has the same structure as the wristband 100A and the components, properties, and features thereof, apply to the wristband 100B. One of the holes 122 at the distal end 110 can be aligned with another one of the holes 122 along the body 102 when the wristband 100B in placed in a loop and a clip can passed through the aligned holes 122 and secured to the wristband to affix the wristband in a loop. Alternatively, the clip can be formed at the distal end 110 and can mate with the holes 122 long the length L_{B} of the wristband 100A. The holes 122 can pass through the substrate 104 and/or the antenna 136.

Any embodiment of the wristbands illustrated herein can include the holes 122 and/or adhesive 120. Where neither the holes 122 nor the adhesive 120 is illustrated, the holes 122 and/or adhesive 120 have been omitted to allow the other elements of the wristbands to be viewed without being obscured. Additionally, while the adhesive 120 has been illustrated in an example position on the wristband, the adhesive 120 can be positioned in other locations in accordance with embodiments of the present disclosure.

Referring to FIGS. 1A-D, the RFID circuit 130 can be disposed along the longitudinal axis L between the proximal end 106 and the distal end 110 of the body 102. In one example, the electronic circuit 132 and/or inductive loop 134 can be positioned closer to one end of the wristband 100A (e.g., offset from a midpoint along the length L_{B} of the wristband 100A, as shown in FIGS. 1A-C. The antenna 136 can be asymmetrical such that a portion of the antenna 136 that extends between the end 106 and the inductive loop 134 inclusive of the antenna segments 136a-c is longer than a portion of the antenna 136 that extends between the end 110 and the inductive loop 134 or extends over more of the length L_{B} of the wristband 100A than a portion of the antenna that extends between the end 110 and the inductive loop 134. While FIGS. 1A-C illustrate an example position of the electronic circuit 132 and inductive loop 134 of the RFID circuit 130 along the length L_{B} of the body 102, the electronic circuit 132 and/or inductive loop 134 can be positioned at other locations along the length L_{B} in accordance with embodiments of the present disclosure.

FIGS. 3A-B illustrates an embodiment of the wristband 100C includes an alternative antenna configuration in accordance with embodiments of the present disclosure. Generally speaking, the structure of the wristband 100C is similar in construction to the wristband 100A. Except where noted in the herein, the description of the wristband 100A and the components, properties, and features thereof, apply to the wristband 100C and for the sake of brevity will not be repeated. As shown in FIG. 3, an antenna 336 of wristband 100C has a crenellated, castellated, or scalloped pattern that has first antenna portions 350 with a first width 360 and second antenna portions 352 with a second width 362, where the first and second portions 350 and 360 alternate along a portion of the length L_{B} of the wristband 100C. Lines of weakness 338a-c can be formed in the second portions 360 of the antenna 336 to define tearable antenna segments 336a-c. Positioning the lines of weakness 338a-c through the second portions 360 of the antenna 336 reduce the amount of the antenna that needs to be torn to remove the antenna segments 336a-c from the wristband.

In some examples, the wristband 100C can include different sets of lines of weakness for the substrate(s) 104 and for the antenna 336. As an example, the first set of the lines of weakness 338a-c can be formed in the substrate to facilitate tearing of the substrate(s) 104 and a second set of lines of weakness 340a-c can be formed in the antenna 336 to facilitate tearing of the antenna 336. As shown in FIGS. 3A-B, the lines of weakness 340a-c can be offset relative to the lines of weakness 338a-c such that the substrate(s) 104 and the antenna 336 tear at different locations for a corresponding one of the antenna segments 336a-c. This can allow the antenna 136 to be recessed relative to a new terminal end of the wristband 100C (at a new proximal end) when one of the antenna segments 336a-c. As an example, when the antenna segments 336b-c are torn from the wristband 100C, as shown in FIG. 3B, the remainder of the antenna 336 can be recessed related to a new end 306 at a new proximal end 308 of the wristband 100C. Recessing the end of the antenna 336 relative the end of the wristband when an antenna segment is torn from the wristband may prevent irritation of a wearer of the wristband 100C from the antenna 336 contacting the skin of the wearer. For example, where the wristband 100C includes two substrates 104 that encompass the antenna 336, a recessed end of the antenna can be fully encompassed by the substrates so that the antenna does not come into contact with the skin of the wearer.

Reference to a wristband 100 herein refers to any one of the embodiments of the wristbands 100A-C described herein. While the wristband 100 has been illustrated as includes a quantity of tearable antenna segments (e.g., three tearable antenna segments), exemplary embodiments of the wristband 100 can include fewer or more tearable antenna segments. As an example, the wristband 100 can include one tearable antenna segment, two tearable antenna segments, three tearable antenna segments, four tearable antenna segments, five tearable antenna segments, and so on. Furthermore, while certain antenna structures and/or types have been illustrated in FIGS. 1A-D, 2, and 3A-B, different antenna structures and/or types can be implemented in accordance with embodiments of the present disclosure. An example, while the antennas 136 and 336 are illustrated as being a dipole antennas, embodiments of the present disclosure can include different types of antennas (e.g., loop antenna, slot antenna, etc.) and/or can have different antenna structures or geometries (e.g., linear, serpentine, etc.). The RFID circuit 130 can be embodied as an RFID inlay, transponder, tag, or other form factor.

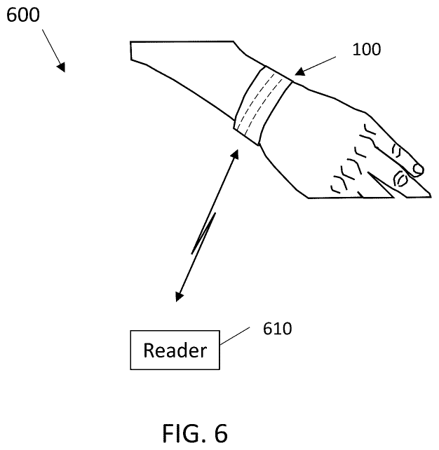

FIG. 4A-C illustrate an example embodiment of the wristband 100 (e.g., corresponding to any one of the wristbands 100A or 100C) in a closed state such that the wristband 100 has a loop configuration in accordance with embodiments of the present disclosure. As shown in FIGS. 4A-C, the wristband 100 is wrapped about itself in a (geometric) loop 400 such that one of the terminal ends (e.g., terminal end 110) of the wristband 100 is wrapped about the other (e.g., terminal end 106) and affixed to the body 102 (e.g., to the surface 104a of the substrate 104) of the wristband 100. The loop 400 can have a diameter D. The diameter D or the loop 400 can vary based on a size of the wearer. In one example, a maximum diameter of the loop 400 formed by the wristband in closed position is between approximately three (3) inches and approximately seven (7) inches when the tearable antenna segments 436 are intact and is between approximately one (1) inch and approximately three (3) inches when all of the antenna segments 436a-c are removed. In one example, a maximum diameter of the loop formed by the wristband in closed position is between approximately three (3) inches and approximately five (5) inches when the tearable antenna segments 436 are intact and is between approximately one (1) inch and approximately two (2) inches when all of the antenna segments 436a-c are removed. The RIFD circuit 130 is contained in the loop 400 and extends circumferentially about the loop 400 (e.g., as opposed to flag style wristband where the RFID circuit is not included in the loop). When the loop 400 is wrapped about the wrist 410 of a wearer, the ends of an antenna 436 (e.g., corresponding to any of the antennas 136 or 336) can overlap one another causing interfere or cause other issues with reception of radiofrequency waves from an RFID reader/interrogator (e.g., RFID reader 610 shown in FIG. 6). As described herein, one or more antenna segments 436a-c (e.g., corresponding to the segments 136a-c or antenna segments 336a-c) can be removed from the wristband along the one or more lines of weakness 438a-c (e.g., corresponding to any of the lines of weakness 138a-c or lines of weakness 338a-c and/or 340a-c) to reduce or eliminate an amount of overlap between the ends of the antenna to reduce or eliminate the interference associated with overlapping ends of the antenna 436 (e.g., any one of the antennas 136 or 336).

FIG. 5 is a block diagram of an example embodiment of the RFID circuit 130 in accordance with embodiments of the present disclosure. As shown in FIG. 5, the electronic circuit 132 of the RFID circuit 130 can include an energy harvesting circuit 510, a logic circuit 520, a demodulator 530, a decoder 540, memory 550, a modulator 560, and an encoder 570. As a non-limiting example, the electronic circuit 132 can be implemented as one or more integrated and/or discrete circuits.

The memory 550 is a non-transitory computer-readable medium that can include volatile (e.g., RAM) and/or non-volatile memory (e.g., EEPROM). The memory 550 can store data, including an identifier, which can be used in a system to identify and distinguish the RFID circuit 130 from other RFID circuits in a system and can also be used to associate the RFID circuit 130 with an object in the system. In an example embodiment, the identifier can be a string of alphanumeric characters. The RFID circuit 130 can be associated with the wristband 100 and/or can be associated with a person, animal, or object about which the wristband 100 are wrapped. For example, when RFID circuit 130 of the wristband 100 are interrogated by an RFID reader, the RFID circuit 130 may respond with the stored identifier to identify itself and the RFID reader and/or other devices can use the association between the identifier, the wristband 100, and/or the wearers of the wristband 100 to determine and/or retrieve information about the wearer, and/or the RFID reader and/or other devices can perform one or more operations based on the receipt of the identifier and/or the information determined and/or retrieved about the wearers of the wristband based on the identifier.

When the RFID circuit 130 is within a read range of the RFID reader/interrogator, radio waves of the far-field radiofrequency communication emitted by the RFID reader can generate a time varying electromagnetic field, which in turn can induce, via inductive coupling, an electrical signal (e.g., an electric current) in the antenna 436 (e.g., any one of the antennas 136 or 336) and the inductive loop 134. As described herein, the antenna 436 can be tearable via lines of weakness to reduce the length of the antenna 436, which can result in an increase the read range of the RFID circuit 130, an increase a read angle of the RFID circuit 130, a reduction of interference that occurs when the ends of the antenna 436 overlap, and/or can allow the RFID circuit 130 to be read by the RFID reader independent of the orientation of the RFID circuit in the wristband relative to a body part of the wearer and position of the RFID reader, e.g., by inducing more power in the RFID circuit 130, particularly when there is radiofrequency interference from a body part of the wearer. The electrical signal can be processed by the energy harvesting circuit 510 to generate a power supply voltage to power the components of the electronic circuit 132. For example, the energy harvesting circuit 510 receives the electrical signal from the inductive loop 134 and converts the electrical signal to a direct current voltage. The energy harvesting circuit 510 can include, for example, a charge pump, voltage converter, voltage regulator, and/or other circuitry. The electrical signal can also include information that can be demodulated by the demodulator 530 and decoded by the decoder 540. The decoded electrical signal can be received as an input by the logic circuit 520 from the decoder 540.

In response to receipt of the decoded electrical signal and when sufficient power is generated from the induced electrical current, the logic circuit 520 can retrieve data from the memory 550 (e.g., the identifier) and output the data to the encoder 570. The logic circuit 520 can include software, firmware, and/or hardware, or any combination thereof to facilitate the operations performed by the logic circuit 520. For example, the logic circuit 520 can include digital circuitry, such as logic gates. The encoder 570 can encode the data from the logic circuit 520 and output the encoded data to the modulator 560, which can modulate the encoded data and output the modulated data to the inductive loop 134, which can, in combination with the antenna 436 modulate the modulated signal onto the far-field radiofrequency communication received by the RFID circuit 130 from the RFID reader.

While an example embodiment of the RFID circuit 130 has been illustrated in FIG. 5, embodiments of the RFID circuit 130 can include more, fewer, and/or different components. As an example, the RFID circuit 130 can include any number of energy harvesting circuits, demodulators, decoders, logic circuits, encoders, and/or modulators.

FIG. 6 is an example environment 600 in accordance with embodiments of the present disclosure. The environment 600 can include far-field RFID reader 610 and an embodiment of the wristband 100 (or wristband 300) wrapped in a loop about a wrist of the wearer. The RFID reader 610 can be disposed at a fixed or stationary location and/or can be moved to different locations. For example, the RFID reader 610 can be spaced away from the RFID circuit 130 to facilitate far-field radiofrequency communication (e.g., RFID reader 610 can be greater than twelve inches, two feet, three feet, four feet, five feet, six feet, seven feet, eight feet, or more from the RFID circuit 130). The RFID reader 610 can attempt to interrogate the RFID circuit 130 by emitting a far-field radiofrequency communication. As described herein, when the wristband 100 (or wristband 300) is wrapped in a loop about the wrist of a wearer and the RFID circuit 130 is included in the loop, the wrist 1010 can cause radiofrequency interfere with reception of radiofrequency waves from an RFID reader/interrogator, particularly when the wrist 1010 is positioned between the RFID circuit 130 and the RFID reader 610. Likewise, when the ends of the antenna 436 overlap, there can also be some degradation in an operation of the RFID circuit 130. The radiofrequency interference can reduce the read range of the RFID circuit 130 such that the RFID circuit 130 needs to be closer to the RFID reader 610 than it normally would need to be without the radiofrequency interference, the power of the radiofrequency waves emitted by the RFID reader 610 would need to be increase to compensate for the interference, or the orientation of the reader or the RFID circuit would need to be adjusted. However, by including the tearable antenna segments (e.g., segments 136a-c or segments 336a-c), a length of the wristband and antenna 436 can be reduced to accommodate different wrist sizes (diameters) and reduce or eliminate an overlap between the ends of the antenna 436 when the wristband 100 is wrapped around a wrist of a wearer.

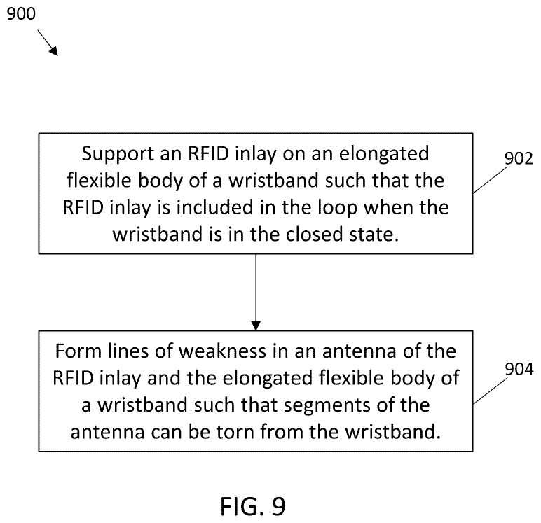

FIG. 9 is a flowchart illustrating an example process 900 of forming an example wristband (e.g., wristbands 100A-C) in accordance with embodiments of the present disclosure. At operation 902, an RFID circuit (e.g., RFID circuit 130) is supported on an elongated flexible body (e.g., body 102) of the wristband. The wristband has an open state in which the wristband is capable of being positioned in a planar configuration and has a closed state in which the wristband is wrapped in a loop (e.g., loop 400) such that a first end (e.g., terminal end 110) of the wristband overlaps a second end (e.g., terminal end 106) of the wristband and is fixed to the body. The RFID circuit is supported by the body by positioning the RFID circuit on the body such that the RFID circuit is configured to be included in the loop 400 when the wristband is in the closed state. At operation 904, one or more lines of weakness (e.g., lines of weakness 138a-c or lines of weakness 338a-c and/or 340a-c) are formed in an antenna (e.g., antenna 136 or 336) of the RFID circuit and/or on the elongated body of the wristband. The one or more lines of weakness allow segments of the antenna (e.g., antenna segments 136a-c or 336a-c) to be torn from the wristband.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A device, comprising:
a wristband having a flexible elongated body, the wristband having an open state in which the wristband is capable of being positioned in a planar configuration and having a closed state in which the wristband is wrapped in a loop such that a first end of the wristband overlaps a second end of the wristband and is fixed to the body;
an RFID circuit supported by the elongated body of the wristband, the RFID circuit being positioned on the body such that the RFID circuit is configured to be included in the loop when the wristband is in the closed state, the RFID circuit including an antenna; and
a line of weakness in the antenna, the line of weakness defines a tearable antenna segment that is removeable to change a length of the antenna.

2. The device of claim 1, wherein the antenna extends over fifty percent to one hundred percent of a length of the elongated body.

3. The device of claim 1, wherein the tearable segment is extends over five percent to fifty percent of the wristband.

4. The device of claim 1, further comprising:
a plurality of lines of weakness include the line of weakness, the plurality of lines of weakness defining a plurality of tearable antenna segments,
the length of the antenna changes based on a quantity of the plurality of tearable antenna segments that are removed.

5. The device of claim 4, wherein a segment length of each tearable antenna segment is between approximately a quarter of an inch and approximately three inches.

6. The device of claim 4, wherein each of the plurality of antenna segments have an equal segment length.

7. The device of claim 4, wherein at least two of the plurality of antenna segments have different segment lengths.

8. The device of claim 4, wherein each of the plurality of antenna segments extend over two percent to twenty-five percent of the length of the elongated body.

9. The device of claim 1, wherein the line of weakness extends across the antenna and the device comprises:
a further line of weakness offset from the line of weakness, the further line of weakness extends across the elongated body,
the line of weakness and the further line of weakness defining the tearable antenna segment,
the antenna being tearable along the line of weakness and the elongated body being tearable along the further line of weakness.

10. The device of claim 9, wherein a portion of the antenna remaining intact in the wristband is offset inward from a remaining end of the elongated body when the tearable antenna segment is removed.

11. The device of claim 1, wherein the elongated body has a length of between eight inches and fifteen inches when the tearable antenna segment is intact and has a length of between three inches and ten inches when the tearable segment is removed.

12. The device of claim 1, wherein the length of the antenna is equal to a wavelength of an interrogation signal to which the RFID circuit is configured to respond when the tearable antenna segment is intact and the length of the antenna is one quarter of the wavelength or one half of the wavelength when the tearable antenna segment is removed.

13. The device of claim 1, wherein the antenna includes first antenna portion and a second antenna portion, the second antenna portion having a width that is less then the first antenna portion and the line of weakness extends across the second antenna portion.

14. The device of claim 1, wherein a maximum diameter of the loop formed by the wristband in closed position is between three inches and five inches when the tearable antenna segment is attached and is between one inch and two and a half inches when the antenna segment is removed.

15. The device of claim 1, wherein the antenna is a dipole antenna.

16. A method, comprising:
supporting an RFID circuit on an elongated flexible body of a wristband, the wristband having an open state in which the wristband is capable of being positioned in a planar configuration and having a closed state in which the wristband is wrapped in a loop such that a first end of the wristband overlaps a second end of the wristband and is fixed to the body, the RFID circuit having an antenna and being positioned on the body such that the RFID circuit is configured to be included in the loop when the wristband is in the closed state; and
forming one or more lines of weakness comprising in the antenna to define tearable antenna segments that are removeable to change a length of the antenna.

17. The method of claim 16, wherein the antenna extends over fifty percent to one hundred percent of a length of the elongated body.

18. The method of claim 16, wherein forming one of more lines of weakness comprises defining the tearable segments to extend over five percent to fifty percent of the wristband.

19. The method of claim 19, wherein forming the one or more lines of weakness comprises forming a plurality of lines of weakness, each of the plurality of antenna segments extend over two percent to twenty-five percent of the length of the elongated body.

20. The method of claim 19, wherein at least one of the plurality of tearable antenna segments is defined by at least two lines of weakness.

21. The device of claim 1, wherein the line of weakness comprises a perforation or a score.
